(19) United States
(12) Patent Application Publication
(10) Pub. No.: US 2016/0379728 A1
(43) Pub. Date: Dec. 29, 2016

(54) YTTRIUM-90 PRODUCTION SYSTEM AND METHOD

(71) Applicant: Global Medical Isotope Systems LLC, Henderson, NV (US)

(72) Inventor: Francis Y. Tsang, Las Vegas, NV (US)

(21) Appl. No.: 15/195,706

(22) Filed: Jun. 28, 2016

Related U.S. Application Data
(60) Provisional application No. 62/185,734, filed on Jun. 29, 2015.

(51) Int. Cl. G21G 1/00; G21G 1/06; G21G 4/02

(52) U.S. Cl. CPC G21G 1/001; G21G 4/02; G21G 1/06; G21G 2001/0094

(57) ABSTRACT

A method of producing the therapeutic medical isotope yttrium-90 (Y-90) is provided that includes providing a zirconium target composed at least partially of Zr-90, directing an electron beam onto a high-Z converter to generate a neutron beam having a maximum energy level of 12.1 MeV, and directing the neutron beam onto the zirconium target to isotopically convert at least a portion of the Zr-90 to the Y-90 medical isotope.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

Field of the Invention

The present invention relates generally to the generation of unstable, i.e., radioactive, nuclear isotopes, and more particularly to a system and method for generating the yttrium-90 medical isotope through neutron-induced reactions.

Description of the Related Art

Yttrium-90 (Y-90) is valuably used as a therapeutic medical radioisotope. It has a short half-life (64.2 hours) and decays to the stable daughter product: zirconium-90 (Z-90). It is a pure β− particle emitting radionuclide with a high average beta energy (energy maximum of 2.27 MeV and energy mean of 0.9367 MeV) and with an average penetration range in tissue of 2.5 mm and a maximum of 11 mm. One gigabecquerel (27 mCi) of Y-90 delivers a total absorbed radiation dose of 50 Gy/kg. In therapeutic use the isotope decays completely in situ, with 94% of the radiation being delivered in 11 days.

Y-90 has established applications as the therapeutic agent used on a monoclonal antibody for targeting cancer cells, used as the radiation source in microspheres for brachytherapy (internal radiation therapy), and used as a locally injected silicate colloid for relieving arthritis pain in larger synovial joints.

The combination of Y-90 with monoclonal antibodies and peptides creates potential “smart drugs” with specific targets. This therapeutic application is currently being used in clinical trials for treating cancers such as ovarian, lung, breast, colon, prostate, brain, non-Hodgkin's lymphoma, and gastrointestinal adenocarcinomas.

Brachytherapy using microspheres with Y-90 has cure rates equal to or better than surgery, while being minimally invasive. Currently there are two commercially available microsphere types that use the Y-90 isotope. One type incorporates the Y-90 within glass microspheres and the other within resin microspheres.

Another valuable use of yttrium-90 is in joint treatments. It is used to alleviate the symptoms of knee joints with recurrent effusions (fluid collections), which only respond temporarily to steroid injections. It is also a suitable treatment for pigmented villonodular synovitis, which is a destructive disease of the synovium (the joint lining). In treating joint problems, radiosynoviorthesis treatments are delivered as a liquid injection of Y-90 colloid into an affected joint. The colloidal particles enter the inner synovial lining cells of the joint. The Y-90 then decays via beta emission, which stops the inflammatory process without causing damage to outer tissues.

Though Y-90 is a therapeutic radionuclide with many benefits, the cost of a dose of Y-90 is quite high. It was stated in a 2003 U.S. Government Accountability Office (GAO) report that the reimbursement value for Y-90 was about $19,500 per dose. An estimate in the Oncologist journal in 2011 placed the cost of Y-90 treatment at over $25,000. A private communication obtained from one of the major U.S. insurance companies stated the current price per dose as

There are two production methods that are currently used to supply the Y-90 used in nuclear medicine in the US. Both involve the use of a nuclear reactor.

The first method of producing Y-90 is the extraction of strontium-90 (Sr-90) from fission product streams after uranium targets are irradiated in a nuclear reactor. Y-90 is a decay product of Sr-90. Since Sr-90 has a half-life of approximately 29 years, i.e., it decays relatively slowly, a large quantity of Sr-90 is needed to produce viable quantities of the Y-90 decay product within a reasonable time period. Moreover, since Y-90 has a short half-life of only approximately 64 hours, to accumulate enough Y-90 for a therapeutic dose (0.4 mCi/kg up to 32 mCi) while the Y-90 remains in its radioactive, useful form, a (relatively) very large quantity of Sr-90 is required.

Typically, an Sr-90 source is milked multiple times over selected intervals to produce Y-90. Beginning in the early 1990's, Pacific Northwest National Laboratory (PNNL) initiated an investigation into the possibility of using a nuclear reactor (Fast Flux Test Facility—FFTF) for the production and extraction of Y-90 from Sr-90. Currently in the U.S., ultra-pure Y-90 radionuclide is generally extracted from Sr-90 nuclear fission waste stored in highly radioactive waste tanks near the Hanford nuclear site using the patented process developed by PNNL. Sr-90 is commercially available in large quantities, but at least two issues make the extraction process very demanding.

First, the chemical properties of Sr-90 mimic calcium. Biologically, this causes any residual Sr-90 to accumulate in a patient's bones with tragic results. This is a strong negative in regard to the production of Y-90 from Sr-90, as the detrimental Sr-90 is not easily removed from the desired Y-90. The radionuclide purity should be greater than 99.998%, or Sr-90 contamination must be less than 2×10-3% or 20 ppm. (See http://www-pub.iaea.org/MTCD/publications/PDF/trs470_web.pdf.) The effort required to create this ultra-pure Y-90 while avoiding any Sr-90 contamination is the largest factor in the extremely high cost of conventionally-produced Y-90. The production and extraction of Y-90 from Sr-90 is a known process addressed in various patent publications, including U.S. Pat. No. 5,512,256, U.S. Pat. No. 7,517,508, US Patent Publication No. 2004/0005272, and PCT Application No. KR2009/001574.

Secondly, in some applications the total absence of contaminating metallic (M+3) impurities is essential, since the chelation of yttrium-90 to many organ-specific therapeutic agents such as antibodies and peptides requires very high specific activity with no competing metallic impurities to compete for the limited chelation sites. This requirement is a secondary cost factor.

A second method of producing Y-90 is via bombardment of Y-89 with neutrons in a nuclear reactor using the Y-89(n,γ)Y-90 reaction. In current nuclear reactor models, the neutron flux is composed primarily of thermalized neutrons. The neutron capture cross-section of Y-89 is shown in FIG. 1. Due to the small values of the neutron capture cross-section, a large amount of Y-89 is required for the production of Y-90. Due to its short half-life, Y-90 decays substantially during shipment to the point-of-use. Since this production method is tied to the reactor, the decaying product must be expeditiously shipped to the point of use, often at a great distance, or the patient must be brought to a site near the reactor. This is the primary reason many facilities choose to use the Sr-90 production method, instead of this Y-89 method.

With the current production methods, the cost per dose of Y-90 is astronomical. Factors that contribute to this high base price are the necessity for high-purity extraction of Y-90 from the Sr-90, the high costs associated with the utilization of highly enriched uranium (HEU), the need for rapid shipment of Y-90 around the country from the reactor production site, the requirement to avoid metallic impurities, and the handling and disposal of high-level wastes.

Accordingly, there is a need for a system and method for producing Y-90 that provides an on-demand production capability, allows for distribution near the point-of-use, and does not risk contamination by dangerous radionuclides (thereby eliminating the current necessity for ultra-high purification techniques needed in the Sr-90 method).

### SUMMARY OF THE INVENTION

The present embodiments are directed to a system and method for the production of yttrium-90 (Y-90) from zirconium-90 (Zr-90). In some embodiments, the method includes loading a zirconium target composed of at least a portion of Zr-90 into an irradiation chamber; utilizing a compact electron accelerator to accelerate electrons to impinge on a high-Z material to produce photons that are then absorbed by the high-Z material to generate neutrons having energies with a maximum energy level below the threshold of a Zr-90(n,2n)Zr-89 reaction (about 12.1 MeV); introducing the neutrons into the irradiation chamber where the neutrons impinge the Zr-90 of the zirconium target to isotopically convert at least a portion of the Zr-90 through the Zr-90(n,p)Y-90 reaction to Y-90; introducing a room temperature ionic liquid (RTIL) into the irradiation chamber to selectively dissolve the Y-90; removing the RTIL from the irradiation chamber; and using an electrolysis technique to recover the Y-90 from the RTIL.

In contrast to the Sr-90(β−)Y-90 method of producing Y-90, this yttrium production system and method using Zr-90(n,p)Y-90 does not involve the highly toxic Sr-90. Therefore, there is no need for costly purification to remove Sr-90 contamination.

In contrast to the Y-89(n,γ)Y-90 production method, this yttrium production system and method using the Zr-90(n,p)Y-90 reaction provides the capability for on-demand production, and distribution near the point-of-use.

In contrast to methods using linear accelerators accelerating heavier particles, such as deuterons, protons, alpha particles and the like, this yttrium production system and method using the Zr-90(n,p)Y-90 reaction uses an electron accelerator to generate high energy electrons, thus introducing the required energy into the system. Electrons impinge on the high-Z target to generate photons, which are absorbed by the high-Z material to generate the needed neutrons having an energy level below the threshold of the Zr-90(n,2n)Zr-89 reaction (about 12.1 MeV). Preferably most neutrons would have an energy level above the threshold of the Zr-90(n,p)Y-90 reaction (about 4.7 MeV). Neutrons in this preferred range create the isotope Y-90, while avoiding the production of undesirable isotopes.

The Zr-90(n,p)Y-90 reaction and other neutron-induced reactions of Zr-90 are shown in the graph of FIG. 2 (obtained from the Japanese Evaluated Nuclear Data Library (JENDL-4) of the Japan Atomic Energy Agency, which provides the neutron-induced reaction data for over 400 nuclides in the incident neutron energy range from 10-5 eV to 20 MeV). This graph shows the production of the desired Y-90 with neutrons having energies from about 4.7 MeV to about 12.1 MeV. As shown in FIG. 2, undesirable isotopes are produced at higher neutron energies. Therefore, the Y-90 production method of the current invention uses neutrons within the energy range of from about 4.7 MeV to about 12.1 MeV.

Though the Zr-90(n,p)Y-90 reaction has been mentioned in passing as potentially useful in the production of Y-90 in US Patent Publication No. 20100215137 by Nagai et al., the method disclosed there uses neutrons in the range of 3.5 MeV to 20 MeV. Using neutrons in this range, as seen in the graph of FIG. 2, causes the production of undesirable isotopes, which would then require separation. The limitation of using neutrons having energies from below 12.1 MeV prevents the contamination of the desired Y-90 with the undesirable isotopes produced above this energy range. Consequently, the instant yttrium production system and method using Zr-90(n,p)Y-90 greatly reduces the cost per dose by eliminating expensive ultra-purification compared to current Sr-90 production methods, as well as the substantial complications, expenses and limitations (such as rapid, long-distance shipment) of using a nuclear reactor of the Y-89 production method.

An object of the present invention is to provide a Y-90 production system and method that produces the medical isotope Y-90 at a greatly reduced cost compared to the production method using Sr-90.

An additional object of the present invention is to provide a Y-90 production system and method that produces the medical isotope Y-90 without the usage of a nuclear reactor.

These and other objects, features, and advantages of the present invention will become more readily apparent from the attached drawings and from the detailed description of the preferred embodiments which follow.

### BRIEF DESCRIPTION OF THE DRAWINGS

The embodiments of the invention will hereinafter be described in conjunction with the appended drawings, provided to illustrate and not to limit the invention, where like designations denote like elements.

FIG. 1 is a graph showing the cross-section 55 of the Y-89(n,γ)Y-90 reaction (of the prior art) versus neutron energy and the cross-section 50 of Zr-90(n,p)Y-90 (of the present embodiments) versus neutron energy.

FIG. 2 is a graph showing the Zr-90(n,p)Y-90 cross-section 50 of the present embodiments versus neutron energy and the cross-sections of the other neutron-induced reactions of Zr-90 versus neutron energy.

FIG. 3 is a conceptual diagram of a device for producing photoneutrons and using these photoneutrons to cause Y-90 production through the Zr-90(n,p)Y-90 reaction of the current embodiments.

FIG. 4 is a graph showing the neutrons per electron production rate versus the energy of produced neutrons for the exemplary high-Z materials lead and uranium.

FIG. 5 is a flowchart summarizing the Y-90 production method using the Zr-90(n,p)Y-90 reaction of the current embodiments, which includes photoneutron production.

FIG. 6 is a flowchart illustrating the initial creation of the irradiation chamber of the current embodiments with the inlet and outlet extraction/circulation piping.

FIG. 7 is a flowchart illustrating the Y-90 extraction from the Zr-90 target of the current embodiments.

Like reference numerals refer to like parts throughout the several views of the drawings.

### DETAILED DESCRIPTION OF THE PREFERRED EMBODIMENT

The present embodiments are directed to a system and method for the production of yttrium-90 (Y-90) from zirconium-90 (Zr-90) utilizing the Zr-90(n,p)Y-90 reaction using neutrons having an energy level below the threshold of the Zr-90(n,2n)Zr-89 reaction (about 12.1 MeV). Using this method of Y-90 production solves the problems of the current Y-90 production methods, thus greatly reducing the cost of the Y-90 product. Utilizing the Zr-90(n,p)Y-90 reaction eliminates the need for very costly purification to remove toxic Sr-90, which is inherent in the current Sr-90(β⁻)Y-90production method. Additionally, no nuclear reactor (required in the Y-89(n,γ)Y-90 production method) is necessary when using this Zr-90 production method; therefore, the Y-90 product can be produced in local or regional production facilities, eliminating the current need for rapid shipment of Y-90 around the country from the reactor production site.

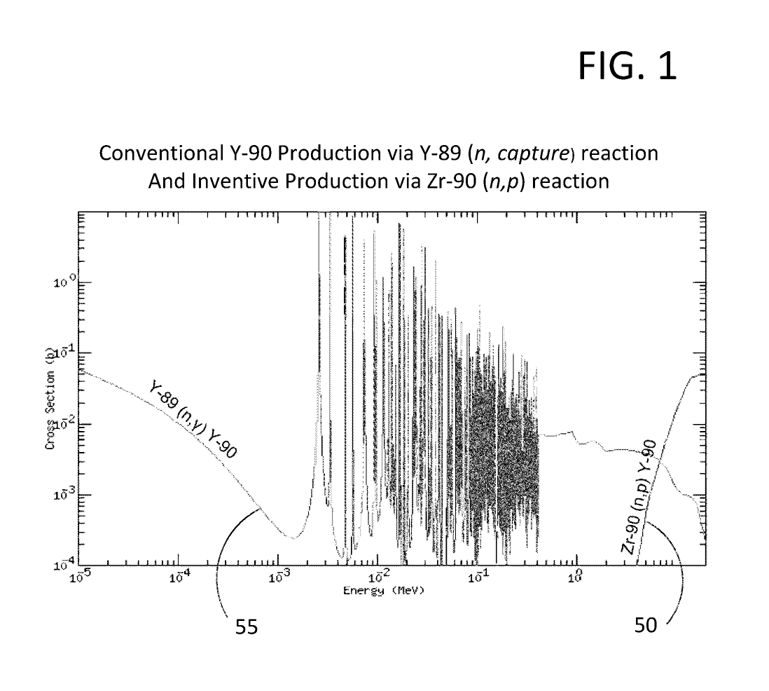

FIG. 1 illustrates the cross-section 55 of the production of Y-90 through the conventional Y-89(n,γ)Y-90 production method of the prior art and the cross-section 50 of the production of Y-90 through the Zr-90(n,p)Y-90 reaction of the current invention. As can be seen from the graph of FIG. 1, the Y-89 production method uses lower energy neutrons, while the Zr-90 production method uses fast neutrons above 4.7 MeV.

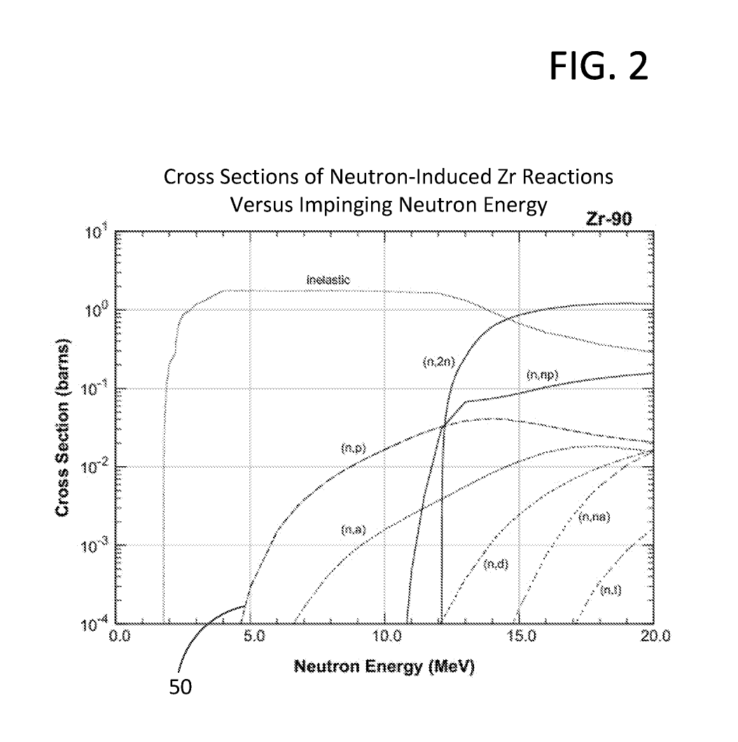

FIG. 2 shows the cross-sections (in barns) of the various neutron-induced Zr reactions versus the impinging neutron energy (in MeV). The Zr-90(n,p)Y-90 reaction has a neutron threshold energy at about 4.7 MeV and reaches a neutron cross-section value of about 30 mbarns at 12.1 MeV. An undesirable competing reaction Zr-90(n,2n)Zr-89 starts at about 12.1 MeV. Though the radiometal Zr-89 (half-life of 78.41 hours) is useful in characterizing tumors using antibody-based positron emission tomography (immuno-PET) imaging, it is a contaminate in the Y-90 production method of the present invention, so is avoided by the careful selection of maximum incident neutron energy. Limiting the neutron energy to a maximum of 12.1 MeV prevents the production of this unwanted isotope, thus eliminating the need to purify the Y-90 to remove the Zr-89 radioisotope. Therefore, an electron beam energy below the Zr-90(n,2n) interaction is desirable in order to eliminate unwanted product impurities within the Zr-90 sample.

The other two competing reactions below 12.1 MeV, Zr-90(n,np)Y-89 and Zr-90(n,alpha)Sr-87, produce the stable isotopes Y-89 and Sr-89.

In FIG. 2, it is shown that an electron beam energy below the Zr-90(n,2n) interaction is desirable in order to eliminate unwanted product impurities within the Zr-90 sample. It is also recognized that the Zr-90(n,alpha)Y-87 reaction will take place when the electron beam energy is above the Zr-90(n,alpha)Y-87 reaction threshold of 6.6 MeV. This Y-87 impurity can be eliminated by using an electron beam energy below the reaction threshold of about 6.6 MeV.

A close examination of the Zr-90(n,alpha)Y-87 reaction cross section indicates that it is an order of magnitude below the desired Zr-90(n,p) reaction energy range of interest and it produces Y-87. Y-87 decay with a positron to Sr-87 which is stable. Y-87m also decays to Sr-87 with a half-life of about 13.4 hours accompanied with a gamma-ray energy of about 380 keV. It is relatively easy to estimate the contribution of Y-87 to the overall performance of Y-90 since both have similar physical and chemical characteristics.

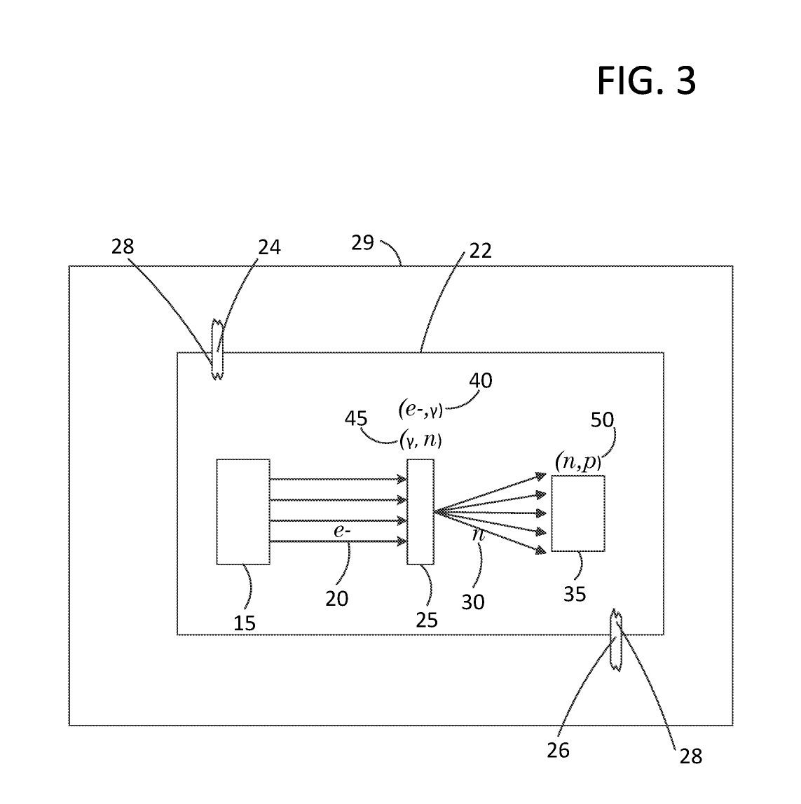

As seen in FIG. 3, the system of this invention includes an electron accelerator 15 producing an electron beam 20 that is directed into a photoneutron producer 25, with the photoneutron producer 25 then producing a neutron beam 30 that radiates from the photoneutron producer 25 into a zirconium target 35. In some embodiments, the zirconium target 35 has a thickness in the range of about 1 cm to about 10 cm.

In the system and method of this embodiment, the radioisotope Y-90 may be produced in a single element of Zr-90 target material, within a series of elements of Zr-90 target material, or within a matrix of elements of Zr-90 target material. Zirconium has five stable isotopes, Zr-90, Zr-91, Zr-92, Zr-94 and Zr-86. Zr-90 is the most naturally abundant at 51.45%. Zirconium can be enriched to contain up to 84-99+% Zr-90. Therefore, the zirconium target 35 may be in the form of a single element, a series of elements, or a matrix of elements and may be natural zirconium or may be zirconium enriched up to over 99% Zr-90. In some embodiments, the zirconium target is in the form of a matrix and is composed of enriched Zr-90.

The electron accelerator 15 is a compact, high-power electron accelerator that generates an electron beam 20 with electrons having an energy below 12.1 MeV. A preferred electron accelerator 15 generates electrons of up to 9.5 MeV and generates electrons above the threshold of the Zr-90(n,p)Y-90 reaction, about 4.7 MeV. The appropriate electron accelerator 15 is chosen based on considerations of economics and technical requirements for successful process implementation.

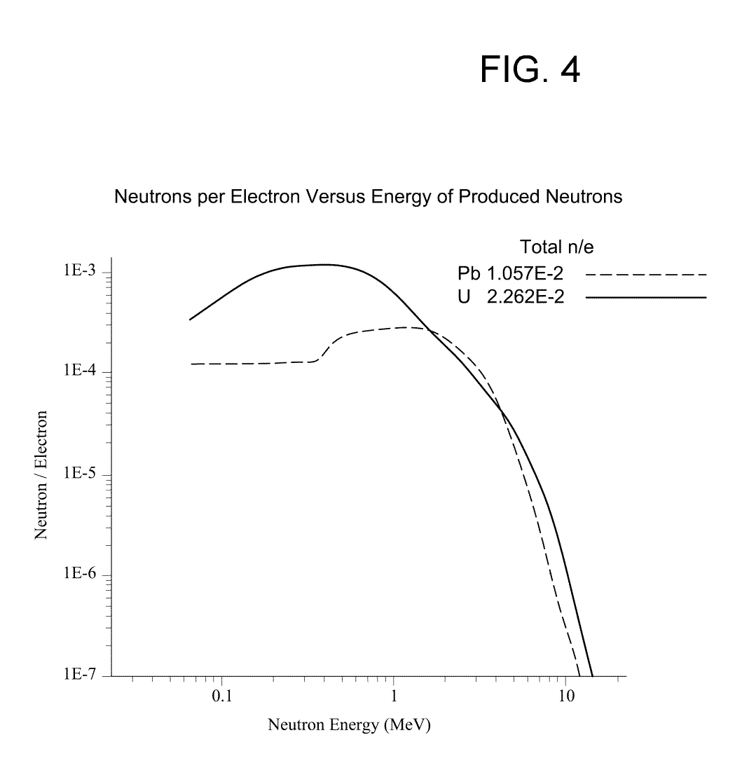

In some embodiments, the photoneutron producer 25 comprises a high-Z material placed in the path of the incident electron beam 20 to convert the relativistic electrons via the (e-,γ) reaction 40 followed by the (γ,n) reaction 45 to a spectrum of neutrons 30 with the neutron maximum energy roughly equal to the maximum incident electron energy. Although any of a number of high-Z materials may be used, exemplary high-Z materials are lead (Pb) and uranium (U). The graph of FIG. 4 illustrates the neutron produced per electron at the neutron energies of 0.1 to 10 MeV for the exemplary high-Z materials of Pb and U.

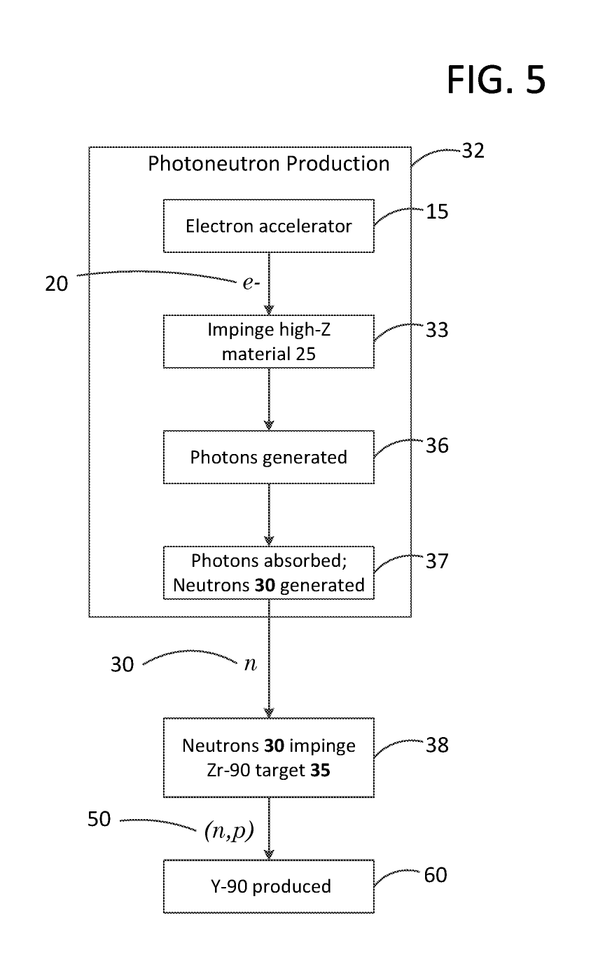

FIG. 5 is a flowchart showing the method of production of the Y-90 isotope using the structure of FIG. 3. Photoneutron production 32 occurs when the electron accelerator 15 generates a high energy electron beam 20 that impinges the high-Z target 25 in step 33 thereby generating photons in step 36. These photons are then absorbed by the high-Z material causing neutrons 30 to be emitted in step 37. The neutrons 30 impinge the Zr-90 of the zirconium target 35 in step 38 and, through the Zr-90(n,p)Y-90 reaction 50, the radioisotope Y-90 is produced in step 60.

As can be seen from the graph of FIG. 2, the generation of Y-90 using neutrons with an energy below 12.1 MeV avoids the production of undesirable isotopes.

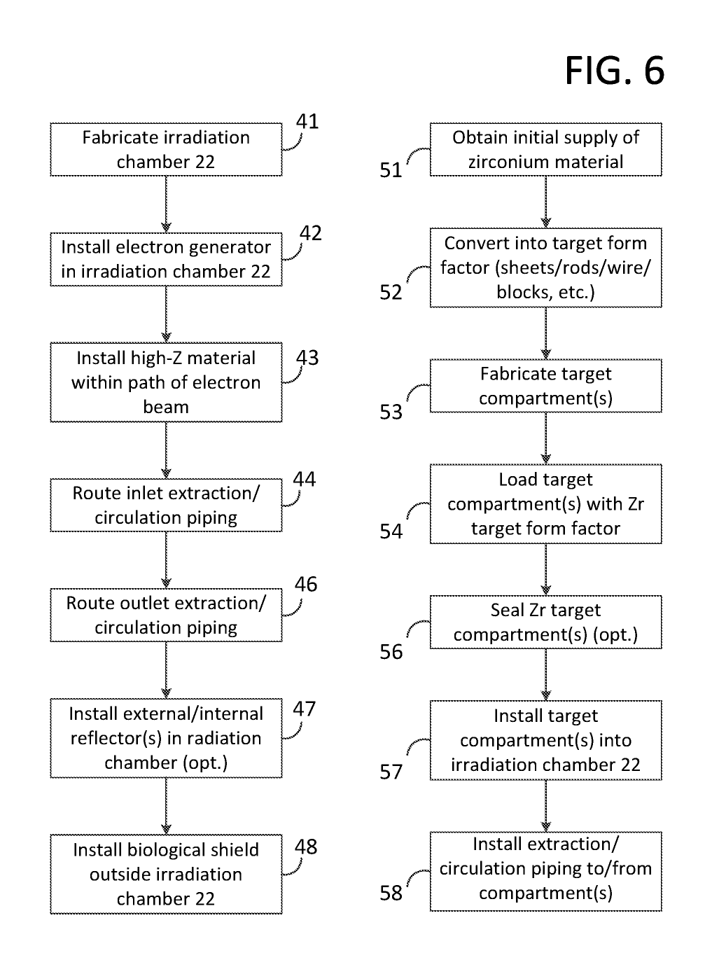

FIG. 6 provides an exemplary method for the initial construction of the Y-90 production system, though the order of the steps may vary. The irradiation chamber 22 is provided or fabricated in step 41 and the electron generator is installed in step 42 within the irradiation chamber 22. A high-Z material 25 is placed within the path of the incident electron beam 20 in step 43.

Extraction/circulation piping 28 is installed by routing it from the inlet 24 into the irradiation chamber 22 in step 44 and by routing it from the outlet 26 into the irradiation chamber 22 in step 46.

In some embodiments, one or more internal reflectors may be installed in step 47 within the irradiation chamber and one or more external reflectors may be installed outside the irradiation chamber. The internal reflectors may be within the Zr target compartment(s), may be outside the Zr target compartment(s), or may be disposed immediately interior of the exterior wall of the irradiation chamber 22. In some embodiments, a biological shield 29 is then installed outside the irradiation chamber 22 in step 48.

An initial supply of zirconium target 35 is obtained in step 51. In some embodiments, the zirconium target 35 material is Zr-90 enriched zirconium. The target 35 material is converted into the desired target form factor in step 52. The physical structure of the zirconium material target may be in the form of sheets, rods, wire, plates, blocks, granules or pellets, or the like. In some embodiments, the zirconium target is formed of natural zircondium materil, In other embodiments, the zirconium target is formed of enriched zirconium material.

One or more compartments that are configured to receive the zirconium target 35 are provided or fabricated in step 53. The interior configuration is based on the physical form factor of the zirconium target 35. In step 54, the compartment(s) are then loaded with the zirconium target 35 and, optionally, are sealed in step 56. The compartment or compartments are then installed into the irradiation chamber 22 in step 57. The irradiation chamber 22 is configured to accommodate the compartment(s).

Extraction/circulation piping 28 is then connected in step 58 from the inlet 24 to the target compartment(s) and from the outlet 26 to the target compartment(s).

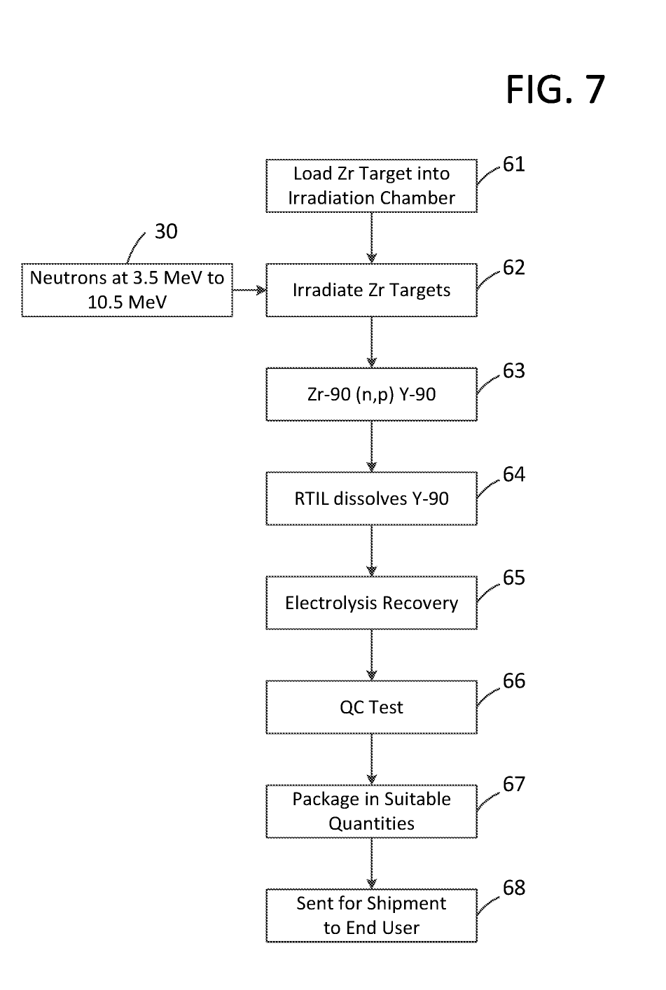

The Y-90 extraction process is presented in overview in FIG. 7. A stream of neutrons having energy below about 12.1 MeV is produced through the photoneutron production method 32 presented in FIG. 5. The zirconium target material is loaded into the irradiation chamber 22 and placed in the path of the neutron beam in step 61. In some embodiments, the target material 35 is preferably loaded first into the one or more compartments that are then placed within the irradiation chamber 22. In other embodiments, the target material 35 may be placed directly into a target receiving area of the irradiation chamber 22. The target material 35 containing Zr-90 is irradiated within the irradiation chamber 22 by the photoneutrons in step 62. In step 63, a portion of the Zr-90 of the zirconium target 35 is converted via the Zr-90(n,p)Y-90 reaction 50 into Y-90, which must then be recovered from the system. In some embodiments, the stream of neutrons has energy mostly above about 4.7 MeV. In some embodiments, over about 50%, over about 60%, over about 70%, over about 80%, or over about 90% of neutrons in the stream have energy above about 4.7 MeV.

In this exemplary embodiment, the Y-90 recovery process uses ionic liquids, and more specifically room-temperature ionic liquids (RTILs). The recovery process includes a series of sub-processes, as will now be described. Initially in step 64, a RTIL is used to selectively dissolve the Y-90 product from the material matrix surfaces leaving the zirconium target 35 intact for reuse. The solution that contains the dissolved Y-90 is then chemically adjusted so that an electrolysis technique can be applied to recover the Y-90 in a solid form in step 65. Optionally, in some embodiments, a quality test may be performed in step 66 before the Y-90 is packaged in suitable quantities in step 67 and shipped to the end user in step 68.

Consequently, the Y-90 production method of the present invention avoids the undesirable production of Y-89 (from the competing Zr-90(n,np)Y-89 reaction) by limiting the energy of the neutrons used to below 12.1 MeV. The extensive ultra-high purification of the conventional Sr-90 method is avoided, along with its high cost. Since no nuclear reactor is required, the relatively compact Y-90 production system of the current invention can be located in convenient regional facilities, thereby providing on-demand production capability.

The invention illustratively disclosed herein may be suitably practiced in the absence of any element which is not specifically disclosed herein.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A method of producing Y-90 by an isotopic conversion reaction comprising:
providing a zirconium target comprising Zr-90;
directing an electron beam onto a high-Z converter to generate a neutron beam having a maximum energy level below the threshold of a Zr-90(n,2n)Zr-89 reaction; and
directing the neutron beam onto said zirconium target to isotopically convert at least a portion of said Zr-90 to a Y-90 isotope.

2. The method of claim 1 wherein said neutron beam has an energy level above the threshold of the Zr-90(n,p)Y-90 reaction.

3. The method of claim 1 wherein the thickness of the zirconium target has a thickness in the range of about 1 cm to about 10 cm.

4. The method of claim 1 wherein the neutron beam has an energy level below about 12.1 MeV.

5. The method of claim 1 wherein the neutron beam has an energy level between about 4.7 MeV and about 12.1 MeV

6. The method of claim 1 wherein said zirconium target is formed of natural zirconium material.

7. The method of claim 1 wherein said zirconium target is formed of enriched zirconium material.

8. The method of claim 1 wherein said high-Z converter is uranium material.

9. The method of claim 1 wherein said high-Z converter is lead material.
